(19) United States
(12) Patent Application Publication
(10) Pub. No.: US 2003/0119965 A1
(43) Pub. Date: Jun. 26, 2003

(54) Method for improving processability and storage stability of a silica filled elastomeric composition

(76) Inventors: Maurizio Galimberti, Milano (IT); Luigi Fino, Bovisio Masciago (IT); Claudio Zanichelli, Nebbiuno (IT); Enrico Albizzati, Lesa (IT)

Correspondence Address: Finnegan Henderson Farabow, Garrett & Dunner, 1300 I Street NW, Washington, DC, 20005, US

(21) Appl. No.: 10/169,163

(22) PCT Filed: Dec. 19, 2000
(86) PCT No.: PCT/EP00/12956

(51) Int. Cl. C08K 3/34; C08K 3/04

(52) U.S. Cl. 524/492; 524/495

(57) ABSTRACT

Method for improving processability and storage stability of a silica filled elastomeric composition, said method comprising adding to said composition a thermoplastic polymer having a main hydrocarbon chain to which hydroxy groups are linked, said polymer having a weight-average molecular weight of at least 8,000. Preferably, the method further comprises adding to the silica filled elastomeric composition a polymer containing functional groups reactive with said hydroxy groups. The polymer containing hydroxy groups is highly effective in reducing and stabilizing viscosity of the composition, even when used in relatively low amounts, while maintaining or even enhancing the reinforcement effect of silica on the elastomeric composition. The resulting composition is particularly suitable to produce tyres, and particularly tyre treads.

### DESCRIPTION

The present invention relates to a method for improving processability and storage stability of a silica filled elastomeric composition, and to elastomeric compositions obtainable therefrom, and also to vulcanized articles, particularly tyres, including said compositions.

In the rubber industry, in particular in the manufacture of tyres for vehicle wheels, the use is known of elastomeric compositions wherein reinforcing fillers have been incorporated in the polymer base, in order to improve the characteristics of the cross-linked product, in particular mechanical properties and abrasion resistance. Thanks to its high reinforcing efficiency, carbon black is the most widely employed reinforcing filler. However, carbon black imparts to the cross-linked product marked hysteretic characteristics, i.e. an increase of heat dissipated in dynamic conditions (heat build-up), which, as is known, causes, in the case of a tyre, an increase in the rolling resistance of the tyre itself. This leads to an increase of the fuel consumption of the vehicles, and hence of both locomotion costs and air pollution. Efforts have been made to reduce such adverse effects by employing smaller amounts of carbon black and/or a carbon black having a smaller surface area. However, a reduction of the reinforcing action inevitably occurs, with a worsening of the mechanical properties and of the abrasion resistance of the final product.

In order to reduce the heat build-up of cross-linked articles it is known to use the so-called “white” reinforcing fillers, such as gypsum, talc, kaolin, bentonite, titanium dioxide, silicates of various types and especially silica, which replaces carbon black either entirely or partly. In this regard, see for example European patent EP-501,227.

However, the use of silica as reinforcing filler for elastomeric compositions has several shortcomings. One of the most apparent drawback is a scarce processability of the unvulcanized compositions, mainly due to an excessive viscosity. Therefore, to achieve a good dispersion of silica in the rubber matrix, an intense and prolonged thermo-mechanical kneading of the composition is necessary. Moreover, the silica particles, having a strong tendency to coalesce even when finely dispersed in a rubber base, impair storage stability of the unvulcanized compositions by forming agglomerates with a remarkable increase of the compound viscosity upon time. Finally, the acid moieties which are present on the silica surface can cause strong interactions with basic substances commonly employed in rubber compositions, such as vulcanization accelerators, thus impairing cross-linking efficiency.

To improve compatibility with the elastomer matrix, silica is usually blended with a coupling agent, for instance a sulfur-containing organosilane product, having two different moieties: the first moiety is able to interact with the silanol groups present on the silica surface, the second moiety promotes interaction with the sulfur-curable elastomers. The use of a combination of silica and a silane coupling agent, while giving a remarkable beneficial effect on the elastomer reinforcement, sets, however, a limit to the maximum temperature that can be reached during the compounding step.

Other efforts have been made in the prior art to solve the above mentioned problems by adding, to the silica filled rubber compositions, compounding agents which should be able to act basically as surface treatment agents for the silica particles.

For instance, European Patent Application EP-801,112 discloses the use of polysiloxane compounds having alkoxysilyl and/or acyloxysilyl groups to increase storage stability of silica filled rubber compositions. The use of such polysiloxane compounds would avoid the problems due to generation of hydrogen gas and gelation deriving from the reaction of the Si—H residual groups commonly present in polysiloxane compounds. A silane coupling agent may be added. To accelerate the reaction between the above polysiloxane compound and/or the silane coupling agent with the silica surface silanol groups, a silanol condensation catalyst is added. This should result in a sufficient coating of the silica surface even using relatively low amounts of the above compounding agents.

European Patent Application EP-890,603 discloses the use, as processing aids to improve processability of silica filled diene elastomer compositions, of hydrogenated and non-hydrogenated fatty acid esters of CS and C6 sugars, or polyoxyethylene derivatives thereof, preferably in the presence of a silane, such as octyltriethoxysilane. Other mineral fillers, such as talc or mica, are also added to inhibit re-agglomeration of silica.

In European Patent Application EP-890,606, a silica filled rubber stock of improved processability is prepared by mixing the rubber base with an amorphous silica filler, from 0 to less than about 1% by weight (based on said silica filler) of bis[3-(triethoxysilyl)propyl]-tetrasulfide (Si69), an alkylalkoxysilane and a curing agent. The addition of a polyol or fatty acid ester as a processing aid is preferred to further reduce the amount of Si69.

In U.S. Pat. No. 5,717,022 other types of processing aids are suggested to improve processability of silica filled rubber compositions, having 1,2 or 1,3 diol groups, wherein at least two chemically bonded carbon atoms and their chemically bonded neighboring carbon atoms are not bound to oxygen atoms. Examples of such compounds are diols (e.g. 1,3-propandiol), polyols (e.g. glicerine) and esters of fatty acids with polyols. The use is also suggested of a partially acetalized polyvinylalcohol with a molecular weight lower than 600.

It is also known in the prior art to introduce hydrophilic polymers, e.g. polymers containing hydroxy groups, in elastomeric compositions, particularly in the rubber compositions used for the manufacture of tyre treads, in order to increase the road grip of the tyre, in particular on wet or iced grounds.

For instance, in Japanese patent application (Kokai) JP-H5-170976 a tyre is described which has an improved road grip on ice or snow grounds, wherein the tread includes short fibers and from 1 to 15 phr of powdered polyvinylalcohol (phr=parts by weight per 100 parts by weight of rubber). The fibers, for instance cellulose or synthetic polymer fibers, are oriented along the circumferential direction of the tyre, so as to impart anisotropic characteristics. Road grip on ice or snow surfaces would be improved by the presence of polyvinylalcohol particles which, when contacted with water, would dissolve, leaving in the tread cavities which increase roughness and hence road grip of the tread. The amount of polyvinyl alcohol powder should not exceed 15 phr, so as not to worsen wear resistance to an unacceptable extent. Besides, low amounts of polyvinylalcohol are necessary not to increase tread stiffness and therefore not to worsen the road grip on dry grounds. Polyvinylalcohol is always employed in rubber compositions containing carbon black as reinforcing filler.

In European patent application EP-896,981, an elastomeric composition for use in tyre tread manufacture is described, which includes modified polyvinylalcohol, in the form of powder or fibers. Such modified polyvinylalcohol has polyoxyalkylene groups along the chain, which increase water solubility of the polymer, hence promoting dissolution of the same when the tread gets in touch with a wet surface, leaving cavities in the tread itself and forming a sticky layer at the interface with the road surface which should increase the tyre road grip.

The use of hydrophilic polymers deriving from starch in elastomeric compositions is described in U.S. Pat. Nos. 5,374,671 and 5,545,680. In particular, such patents describe elastomeric compositions comprising from 1 to 50 phr of a hydrophilic polymer having a glass transition temperature (Tg) ranging from 150° C. to 0° C. depending upon the absorbed amount of water. Such hydrophilic polymer is a destructured starch comprising amylose, amylopectine, or mixtures thereof. The presence of the destructured starch in a rubber composition for tyre treads is said to increase traction on wet grounds, while reducing at the same time rolling resistance on dry roads. The destructured starch may be homogeneously dispersed throughout the elastomeric matrix or, preferably, it is immiscible with the polymeric matrix so that it tends to form fibers, preferably oriented fibers, within said matrix. Since destructured starch is a hydrolyzable and biodegradable polymer, its presence in a tyre is said to increase its biodegradability. A grafting agent may be added to the rubber composition, in order to bind the hydrophilic polymer to the elastomeric base. No indications are given either about the grafting agent to be used, or on how to accomplish such grafting. Destructured starch may be compounded with silica, however no effects on processability or storage stability were reported.

U.S. Pat. No. 5,672,639 describes an elastomeric composition reinforced with a destructured starch combined with a plasticizer compatible with the destructured starch, so as to form a starch/plasticizer composite. With respect to destructured starch as such, said composite is said to have a better miscibility in the elastomeric matrix and would therefore prevent the formation of agglomerates of not dispersed starch. The plasticizer has a softening point lower than the softening point of destructured starch. In particular, poly(ethylene-vinylalcohol) having a softening point lower than 160° C., preferably comprised between 90° and 130° C., may be employed as a plasticizer. Other products which may be used as plasticizers include: ethylene/vinylacetate copolymers, ethylene/glycidylacrylate copolymers and ethylene/maleic anhydride copolymers, cellulose acetate, diesters of dibasic organic acids, and the like. The addition of a coupling agent having a group which reacts with the hydroxyl groups of the composite and a group capable of interacting with the elastomeric matrix is suggested in order to couple the starch/plasticizer composite with the elastomeric matrix. To that aim, the use of coupling agents normally employed in silica-containing rubber compositions, in particular an organosilane tetrasulfide, is indicated. The destructured starch/plasticizer composite may be compounded with silica, however no effects on processability or storage stability were reported.

In the Applicant's view, the compounding agents suggested in the prior art discussed above to improve processability of silica filled elastomeric compositions give unsatisfactory results. For instance, polysiloxanes are in fact scarcely reactive with the silanol groups on the silica surface, therefore they can reduce the viscosity of the rubber compositions substantially by acting as plasticizers, their interaction with silica being very poor. The addition of a silanol condensation catalyst, as taught in EP-801,112, gives a scarce, or even negligible, improvement. Also the low molecular weight products containing hydroxyl groups suggested, for instance, in EP-890,603 and US-5,717,022, basically acts as plasticizers.

According to the Applicant's experience, the use of the above processing aids as plasticizers, while reducing the viscosity of the rubber compound, cause a remarkable reduction of the reinforcement effect of silica, thus resulting in a worsening of tensile and elastic properties of the cross-linked articles obtained therefrom. Moreover, the negative influence on tensile and elastic properties is clearly enhanced when the above processing aids are added in relatively high amounts to increase their effectiveness as plasticizers.

The Applicant has now found that a silica filled elastomeric composition having improved processability and storage stability can be obtained by adding to said composition a thermoplastic polymer having a main hydrocarbon chain to which hydroxy groups are linked, said polymer containing hydroxy groups having a weight-average molecular weight of at least 8,000. The above thermoplastic polymer is highly effective in reducing and stabilizing viscosity of the composition, even when used in relatively low amounts, while maintaining or even enhancing the reinforcement effect of silica on the elastomeric composition. In other words, contrary to the teachings of the prior art, a remarkable improvement of processability and storage stability of the elastomeric compositions can be achieved combined with a reinforcing effect. Therefore, the polymer containing hydroxy groups is able to exert a reinforcing action on the elastomeric material, thus replacing, at least partially, the conventional reinforcing fillers, while keeping excellent, both tensile and dynamic, mechanical properties.

Additionally, the Applicant has found that the above beneficial effects on processability and storage stability can be even enhanced by adding to the silica filled composition the above thermoplastic polymer containing hydroxy groups and a polymer having groups reactive with said hydroxy groups. The resulting cross-linked articles have even improved tensile and elastic properties, deriving from an enhanced reinforcement of the material. Conversely, the Applicant has found that the addition to the elastomeric composition of a destructured starch combined with poly(ethylene-vinylalcohol) having a softening point lower than 160° C. as plasticizer (as disclosed in U.S. Pat. No. 5,672,639) has a detrimental affect both on the elastic properties of the vulcanized composition and, particularly, on the abrasion resistance.

Therefore, in a first aspect, the present invention relates to a method for improving processability and storage stability of a silica filled elastomeric composition, said method comprising mixing at least an elastomeric diene polymer with a reinforcing filler comprising silica, characterized in that said method further comprises adding to said composition a thermoplastic polymer having a main hydrocarbon chain to which hydroxy groups are linked, said polymer containing hydroxy groups having a weight-average molecular weight of at least 8,000, preferably from 10,000 to 150,000, more preferably from 12,000 to 50,000.

In a preferred embodiment, said polymer containing hydroxy groups has a melting point of at least 160° C., more preferably from 170° C. to 230° C., even more preferably from 180° C. to 220° C.

According to a preferred aspect, the method further comprises adding to the silica filled elastomeric composition a polymer containing functional groups reactive with said hydroxy groups.

According to another aspect, the present invention relates to an elastomeric composition comprising:

at least an elastomeric diene polymer;

at least a reinforcing filler comprising silica;

at least a thermoplastic polymer having a main hydrocarbon chain to which hydroxy groups are linked, said polymer containing hydroxy groups having a weight-average molecular weight of at least 8,000, preferably from 10,000 to 150,000, more preferably from 12,000 to 50,000;

with the proviso that, when said polymer containing hydroxy groups is poly(ethylene-vinylalcohol), the composition is substantially devoid of destructured starch.

According to a further aspect, the present invention relates to an elastomeric article obtained by cross-linking the above elastomeric composition.

In another aspect, the present invention relates to a tyre for vehicle wheels comprising at least an element including an elastomeric material, characterized in that said elastomeric material is obtained by cross-linking a composition comprising:

at least an elastomeric diene polymer;

at least a reinforcing filler comprising silica;

at least a thermoplastic polymer having a main hydrocarbon chain to which hydroxy groups are linked, said polymer containing hydroxy groups having a weight-average molecular weight of at least 8,000, preferably from 10,000 to 150,000, more preferably from 12,000 to 50,000.

According to a preferred aspect, said element including said composition is a tread belt.

In a further aspect, the present invention relates to a tread belt comprising the above elastomeric composition.

In the present description and claims, by the expression “thermoplastic polymer having a main hydrocarbon chain to which hydroxy groups are linked” (for the sake of conciseness also “polymer containing hydroxy groups”) it is meant a synthetic polymer wherein hydroxy groups, either directly or through side groups, are linked to the main hydrocarbon chain, said chain being either linear or branched and free from glycoside bonds. As known, glycoside bonds are ether bonds, cleavable by hydrolysis, deriving from polycondensation of monosaccharides, which are typically present in polysaccharides such as starch and cellulose.

The average molecular weight of the polymer containing hydroxy groups according to the present invention may be determined by known techniques, usually by Gel Permeation Chromatography (GPC). The melting point of the polymer containing hydroxy groups may be determined by means of differential thermal analysis using a technique well known to anyone skilled in the art, such as a Differential Scanning Calorimeter (DSC) equipment.

According to a preferred embodiment, the polymer containing hydroxy groups is added to the elastomeric composition in an amount of from 0.1 to 60 phr, more preferably from 1 to 30 phr, even more preferably from 2 to 15 phr. As is known, “phr” means parts by weight per 100 parts by weight of elastomeric base.

Preferably, the polymer containing functional groups reactive with the hydroxy groups (in the following also referred to, for the sake of conciseness, “functionalized polymer”) is added to the elastomeric composition in an amount so as to obtain a weight ratio between the polymer containing hydroxy groups and the functionalized polymer comprised between 0.5:1 and 10:1, preferably between 1:1 and 5:1.

Preferably, the polymer containing hydroxy groups according to the present invention is capable to absorb at least 0.1% by weight of water based on the polymer weight, after a 24-hour exposure in an environment having a 50% relative humidity at the temperature of 24° C. (according to standard method ASTM D570).

The polymer containing hydroxy groups according to the present invention may be selected in particular from: polyhydroxyalkylacrylate, polyvinylalcohol, vinylalcohol/vinylacetate copolymers, ethylene/vinylalcohol copolymers, ethylene/vinylalcohol/vinylacetate terpolymers, and mixtures thereof.

According to a particularly preferred embodiment, said polymer containing hydroxy groups comprises repeating units having the formula

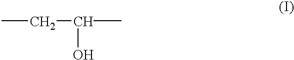

with a random or block distribution along the chain.

This preferred class of polymer containing hydroxy groups includes: polyvinylalcohol, ethylene/vinylalcohol C polymers, ethylene/vinylalcohol/vinylacetate terpolymers. Polymers may also be used wherein the groups of formula (I) have been at least partially modified, for instance by partial acetylation with aliphatic aldehydes (as described, for instance, in U.S. Pat. No. 4,002,796).

The following are particularly preferred:

(i) vinylalcohol polymers obtained by hydrolysis of polyvinylacetate, with a hydrolysis degree of from 50 to 100 mol %, preferably from 70 to 90 mol %;

(ii) ethylene/vinylalcohol copolymers having a content of ethylene units generally of from 20 to 60 mol %, preferably from 25 to 50 mol %.

Copolymers of type (i) are commercially available under the trademarks Mowiol® (Clariant), Gohsenol® (Nippon Gohsei), Elvanol® (Du Pont), Airvol® (Air Products). Copolymers of type (ii) are commercially available under the trademark Soarnol® (Atochem).

Preferably, the functionalized polymer employable in the present invention is a thermoplastic hydrocarbon polymer containing groups selected from: carboxylic groups, anhydride groups, ester groups, silane groups, epoxy groups, or combinations thereof. The amount of functional groups present in the polymer is generally from 0.05 to 50 parts by weight, preferably from 0.1 to 10 parts by weight, based on 100 parts by weight of the polymer.

The functional groups may be introduced during the production of the polymer, by co-polymerization with corresponding functionalized monomers containing at least one ethylene unsaturation, or by subsequent modification of the hydrocarbon polymer by grafting said functionalized monomers in the presence of a free radical initiator (in particular, an organic peroxide).

Alternatively, it is possible to introduce the functional groups by reacting pre-existing groups of the hydrocarbon polymer with a suitable reagent, for instance by an epoxydation reaction of a diene polymer containing double bonds along the main chain and/or as side groups with a peracid (for instance, m-chloroperbenzoic acid or peracetic acid) or with hydrogen peroxide in the presence of a carboxylic acid or a derivative thereof.

In particular, the base hydrocarbon polymer may be selected from:

(a) ethylene homopolymers or copolymers of ethylene with an alpha-olefin having from 3 to 12 carbon atoms (preferably propylene or 1-octene), comprising in general from 35 to 97 mol % of ethylene and from 3 to 65 mol % of alpha-olefin;

(b) propylene homopolymers or copolymers of propylene with ethylene and/or an alpha-olefin having from 4 to 12 carbon atoms (preferably 1-butene), the total amount of ethylene and/or alpha-olefin being less than 10 mol %;

(c) polymers of conjugated diene monomers having from 4 to 12 carbon atoms (preferably 1,3-butadiene, isoprene or mixtures thereof), possibly copolymerized with a monovinylarene having from 8 to 20 carbon atoms (preferably styrene) in an amount not higher than 50% by weight;

(d) homopolymers of monovinylarenes (in particular styrene) or copolymers thereof with ethylene.

Functionalized monomers which may be used include for instance: silanes containing at least one ethylene unsaturation; epoxy compounds containing at least one ethylene unsaturation; monocarboxylic or, preferably, dicarboxylic acids containing at least one ethylene unsaturation, or derivatives thereof, in particular anhydrides or esters.

Examples of silanes containing at least one ethylene unsaturation are: gamma-methacryloxypropyltrimethoxy-silane, allyltrimethoxy-silane, allyltriethoxy-silane, allylmethyldimethoxy-silane, allylmethyldiethoxy-silane, vinyltris(2-methoxyethoxy)-silane, vinyltrimethoxy-silane, vinylmethyldimethoxy-silane, vinyltriethoxy-silane, and the like, or mixtures thereof.

Examples of epoxy compounds containing at least one ethylene unsaturation are: glycidyl acrylate, glycidyl methacrylate, itaconic acid monoglycidyl ester, maleic acid glycidylester, vinylglycidyl ether, allylglycidyl ether, and the like, or mixtures thereof.

Examples of monocarboxylic or dicarboxylic acids containing at least one ethylene unsaturation are: maleic acid, maleic anhydride, fumaric acid, citraconic acid, itaconic acid, acrylic acid, methacrylic acid, and the like, and anhydrides or esters derived therefrom, or mixtures thereof. Maleic anhydride is particularly preferred.

Polyolefins grafted with maleic anhydride are available as commercial products identified for instance by the trademarks Fusabond® (Du Pont), Orevac® (Elf Atochem), Exxelor® (Exxon Chemical), Yparex® (DSM).

The elastomeric diene polymers usable as polymeric base in the present invention may be selected from those commonly used in sulfur-vulcanizable elastomeric compositions, particularly suitable for tyre manufacture, i.e. among unsaturated chain elastomeric polymers or copolymers having a glass transition temperature generally lower than 20° C., preferably comprised between 0° and −90° C. Such polymers or copolymers may be of natural origin or may be obtained by solution or emulsion polymerization of one or more conjugated diolefins, possibly mixed with one or more monovinylarenes in an amount generally not higher than 50% by weight.

Generally, the conjugated diolefins have from 4 to 12, preferably from 4 to 8, carbon atoms, and may be selected from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, and the like, or mixtures thereof. 1,3-butadiene and isoprene are particularly preferred.

Monovinylarenes that may be used as comonomers generally have from 8 to 20, preferably from 8 to 12 carbon atoms, and may be selected for instance from: 1-vinylnaphthalene; 2-vinylnaphthalene; various alkyl, cycloalkyl, aryl, alkylaryl or arylalkyl styrene derivatives, such as for instance: alpha-methylstyrene, 3-methylstyrene, 4-propylstyrene, 4-cyclohexylstyrene, 4-dodecylstyrene, 2-ethyl-4-benzylstyrene, ⁴-p-tolylstyrene, 4-(4-phenylbutyl)styrene, and the like, or mixtures thereof. Styrene is particularly preferred.

Preferably, the elastomeric diene polymers usable as a polymeric base in the present invention may be selected from: cis-1,4-polyisoprene (either natural or synthetic, preferably natural rubber), 3,4-polyisoprene, poly-1,3-butadiene (in particular, high vinyl 1,3-polybutadiene having a content of 1,2-polymerized units comprised between 15 and 85% by weight, and cis-1,4-polybutadiene), polychloroprene, possibly halogenated isoprene/isobutene copolymers, 1,3-butadiene/acrylonitrile copolymers, styrene/1,3-butadiene copolymers, 1,3-butadiene/isoprene copolymers, styrene/isoprene/1,3-butadiene copolymers, butadiene/acrylonitrile copolymers, and the like, or mixtures thereof.

Diene polymers functionalized by reaction with suitable terminating or coupling agents may also be employed. In particular, diene polymers obtained by anionic polymerization in the presence of an organometal initiator (in particular, an organo-lithium initiator) may be functionalized by reaction of the organometallic residues deriving from the initiator with suitable terminating or coupling agents such as imines, carbodiimides, alkyltin halides, substituted benzophenones, alkoxy- or aryloxy silanes (see, for instance, European patent EP-451,604 and U.S. Pat. Nos. 4,742,124 and 4,550,142).

Silica is added to the compositions according to the present invention, in an amount preferably of from 0.1 to 120 phr, more preferably from 20 to 90 phr (phr=parts by weight per 100 parts of polymer base). The silica usable according to the present invention may generally be pyrogenic silica or, preferably, precipitated silica, having a BET surface area comprised between 50 and 500 m²/g, preferably between 70 and 200 m²/g (measured according to ISO standard 5794/1).

Additional reinforcing fillers may be added, such as: carbon black, alumina, aluminum silicates, calcium carbonate, kaolin and the like, or mixtures thereof. Carbon black is particularly preferred. The carbon black grades usable according to the present invention may be selected from those conventionally used in tyre manufacture, generally having a surface area not smaller than 20 m²/g (determined by CTAB absorption as described in ISO standard 6810).

In the compositions according to the present invention a silica coupling agent may be advantageously incorporated, which is capable of interacting with silica and to bind the latter to the elastomeric base during vulcanization.

Coupling agents of preferred use are those based on silane, identifiable for instance by the following structural formula:

(R)₃Si—CₙH₂ₙ—X (II)

wherein:

groups R, equal or different from each other, are selected from: alkyl, alkoxy, aryloxy groups or. halogen atoms, with the proviso that at least one of the R groups is an alkoxy or aryloxy group;

n is an integer of from 1 to 6;

X is a group selected from: nitrous, mercapto, amino, epoxy, vinyl, imido, chloro, —(S)ₘ—CₙH₂ₙ—Si(R)₃, wherein m and n are integers of from 1 to 6, and the R groups are as defined above.

Among them, the silane-based coupling agent bis(3-trietoxysilylpropyl)tetrasulfide (Si69) is particularly preferred, either as such or suitably mixed with a small amount of inert filler (for instance, carbon black) to facilitate the incorporation of the same in the rubber composition.

The method according to the present invention may further include adding to the silica filled elastomeric compositions an effective amount of a silanol condensation catalyst.

The silanol condensation catalyst may be generally added in an amount of from 0.05 to 7% by weight, preferably from 0.1 to 5% by weight, with respect to the weight of silica.

The silanol condensation catalyst can be selected from those known in the art for condensation reactions, and in particular:

carboxylates of metals such as tin, zinc, zirconium, iron, lead, cobalt, barium, calcium, manganese and the like, for example: dibutyltin dilaurate, dibutyltin diacetate, dioctyltin dilaurate, stannous acetate, stannous caprylate, lead naphthenate, zinc caprylate, zinc naphthenate, cobalt naphthenate, ferrous octanoate, iron 2-ethyl hexanoate, and the like;

arylsulphonic acids or derivatives thereof, for example: p-dodecylbenzenesulphonic acid, tetrapropyl-benzenesulphonic acid, acetyl p-dodecylbenzenesulphonate, l-naphthalene sulphonic acid, 2-naphthalene sulphonic acid, acetylmethyl sulphonate, acetyl p-toluenesulphonate, and the like;

amines and alkanolamines, for example ethylamine, dibutylamine, hexylamine, pyridine, dimethylethanolamine and the like;

or mixtures thereof.

Particularly preferred is dibutyltin dilaurate.

The compositions according to the present invention may be vulcanized according to known techniques, and in particular with sulfur-based vulcanizing systems commonly employed for diene elastomers. To this purpose, after a first thermal-mechanical working steps, sulfur or a sulfur-containing vulcanizing agent is incorporated in the composition together with vulcanization activators and accelerators. In this second working step, the temperature is generally kept below 120° C., preferably below 100° C., to prevent undesired pre-cross-linking phenomena.

The vulcanizing agent of most advantageous use is sulfur or sulfur-containing molecules (sulfur donors) with accelerators and activators known to anyone skilled in the art.

Particularly effective activating agents are zinc compounds and in particular ZnO, ZnCO₃, zinc salts of fatty acids, saturated or unsaturated, having from 8 to 18 carbon atoms, such as for instance zinc stearate, preferably formed in situ in the rubber composition starting from ZnO and fatty acid, as well as BiO, Pbo, Pb₃O₄, PbO₂, and mixtures thereof.

Accelerators of common use may be selected from: dithiocarbamates, guanidines, thioureas, thiazoles, sulphenamides, tiourams, amines, xanthates, and the like, or mixtures thereof.

The compositions according to the present invention may include other additives of common use selected on the basis of each specific application they are intended for. For instance, the following may be added to said compositions: antioxidants, antiageing agents, plasticizers, adhesive agents, antiozonants, modifying resins, fibers (for instance, Kevlar® pulp), and the like.

In particular, in order to further improve processability, a plasticizer, generally selected from mineral oils, vegetable oils, synthetic oils and the like, or mixtures thereof, for instance: aromatic oil, naphthene oil, phthalates, soybean oil, and the like, may be added to the cross-linking compositions of the present invention. The amount of the plasticizer may generally range between 2 and 100 phr, preferably between 5 and 50 phr.

The preparation of the compositions according to the present invention may be carried out by mixing the polymer components with the reinforcing filler and the other additives according to techniques known in the art. Mixing may be carried out for instance by means of an open-mill type mixer, or by means of an internal mixer of the type with tangential (Banbury) or interpenetrating (Intermix) rotors, or in continuous mixers of the Ko-Kneader (Buss) type, or of twin-screw co-rotating or counter-rotating type.

The polymer containing hydroxy groups, and the functionalized polymer as optional component, may be used in the form of powder, beads or pellets. In order to improve mixing with the other components, such polymers may be used combined with a plasticizer, such as glycerin, pentaerythrite, and the like. Preferably, the compositions according to the present invention are produced in two steps. In a first step, the polymer containing hydroxy groups, and possibly the functionalized polymer, is mixed with a portion of the elastomeric base, thereby forming a masterbatch. In a subsequent step, the masterbatch is mixed with the remaining portion of the elastomeric base and the other components, according to conventional methods. The first preparation step of the masterbatch is preferably carried out in a continuous mixer, for instance a twin-screw extruder, at a temperature of more than 120° C., so as to obtain an excellent dispersion of the thermoplastic polymers in the elastomeric base. The continuous mixers of preferred use are characterized by an adjustable geometry of the screw and thermal profile of the cylinder. Preferably, the masterbatch is prepared in a continuous mixer at a temperature of from 180° to 230° C., more preferably from 190° e 230° C.

Now the present invention will be further illustrated by some examples, with reference to:

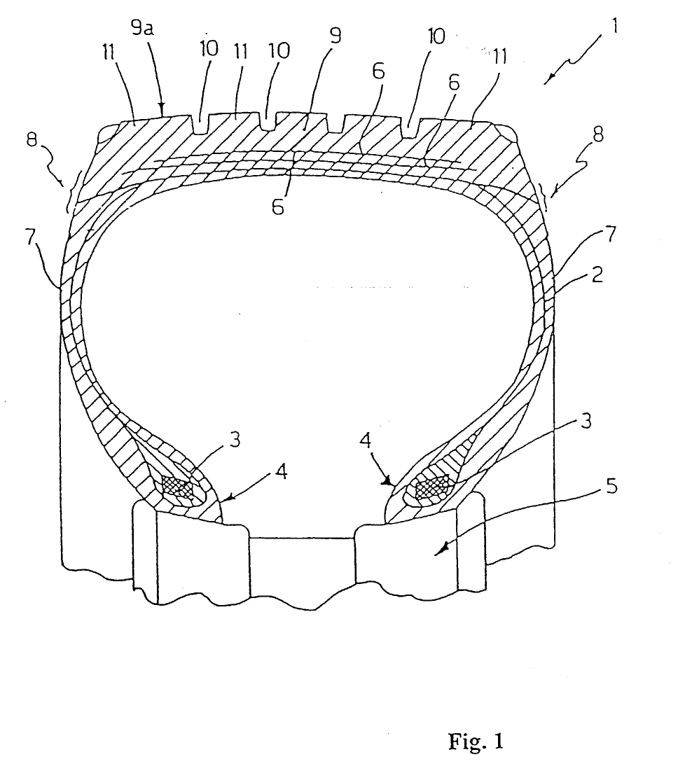

the attached FIG. 1, which shows a partly interrupted view in cross-section of a tyre according to the invention.

With reference to FIG. 1, a tyre 1 conventionally comprises at least one carcass ply 2 whose opposite side edges are coupled with respective bead wires 3, each incorporated in a bead 4 along a circumferential internal edge of the tyre, at which said tyre engages on a rim 5 which makes part of a vehicle wheel. The coupling between the carcass ply 2 and the bead wires 3 is usually achieved by bending the carcass ply 2 around the bead wires 3, as shown in FIG. 1.

Alternatively, the conventional bead wires 3 may be substituted by a couple of circumferentially inestensible annular inserts in the form of elongated elements extending in concentric coils (not represented in FIG. 1) (see for instance European patent applications Nos. 928,680 and 928,702). In the latter case the carcass ply 2 is not bended around the bead wires 3, the coupling between them being provided by a second carcass ply (not represented in FIG. 1) externally applied to the first one.

Along the circumferential development of the carcass ply 2 one or more belt strips 6, made of textile or metal chords incorporated in a sheet of rubber composition, are applied. Externally to the carcass ply 2, in respective opposite side portions of the same, a couple of sidewalls 7 is applied, each of which extends from the bead 4 up to a so-called “shoulder” zone 8 of the tyre, defined at the opposite ends of the belt strip 6. A tread 9, whose side edges terminate at the shoulders 8, connecting with the side walls 7, is circumferentially applied on the belt strips 6. The tread 9 is externally provided with a rolling surface 9a, intended for getting in touch with the ground, wherein circumferential grooves 10 may be formed, intercalated with transversal slits, not shown in the attached figure, which define a plurality of blocks 11, variously distributed on said rolling surface 9a.

The production process of the tyre according to the present invention may be carried out with techniques and apparatuses known in the art. More particularly, such process usually comprises an assembling step of the green tyre, wherein several semi-finished products, previously and separately prepared from each other and corresponding to the different parts of the tyre (carcass plies, belt strips, bead wires, fillings, sidewalls and treads) are associated with each other with a suitable assembling machine. Alternative processes for producing a tyre or parts thereof without using semi-finished elements are described, for instance, in the above cited patent applications EP-928,680 and EP-928,702.

Afterwards, the green tyre thus obtained is transferred to the subsequent shaping and cross-linking steps. To this end, a vulcanization mould is used, adapted to house the tyre under working within a moulding cavity having walls counter-shaped with respect to the outer surface of the tyre once the cross-linking has been completed.

Shaping of the green tyre may be carried out by feeding a pressurized fluid into the space defined by the tyre inner surface, in order to press the outer surface of the green tyre against the walls of the molding cavity. In one of the most widely used shaping methods, a vulcanization chamber made of elastomeric material, filled with vapor and/or other fluids, is inflated within the tyre enclosed in the molding cavity. In this way, the green tyre is pushed against the inner walls of the molding cavity, obtaining the desired shaping. Alternatively, shaping may be carried out without an inflatable vulcanization chamber, by preparing within the tyre a toroidal metal support shaped in accordance to the configuration of the inner surface of the tyre to be obtained (see for instance patent EP-242,840). The different coefficient of thermal expansion between the toroidal metal support and the green elastomeric material is exploited to achieve an adequate molding pressure.

At this point, the cross-linking step of the green elastomeric material present in the tyre is carried out. To this aim, the outer wall of the vulcanization mold is caused to get in touch with a heating fluid (generally, vapor), so that the outer wall reaches a maximum temperature generally comprised between 100° C. and 230° C. At the same time, the inner surface of the tyre is brought to the cross-linking temperature with the same pressurized fluid employed to press the tyre against the walls of the molding cavity, heated up to a maximum temperature comprised between 100° C. and 250° C. The time necessary to obtain a satisfactory degree of cross-linking throughout the mass of the elastomeric material may generally range between 3 min and 90 min, and mainly depends on the tyre size.

Some examples to further illustrate the present invention are reported in the following.

### EXAMPLES 1-3

Preparation of the Masterbatch.

Compositions according to the present invention (masterbatch) as reported in Table 1 (the amounts are expressed as % by weight of the total) were prepared as follows.

A dry blend of the ingredients was fed to a parallel twin-screw (co-rotating) extruder having a length/diameter ratio L/D=30. The maximum temperature reached during the extrusion was of 200° C. ±5° C. The masterbatch was air cooled.

TABLE 1

| Example | 1 | 2 | 3 |
|---|---|---|---|
| SBR | 75 | 75 | 75 |
| PVA | 19 | 21 | 25 |
| PE-MA | 6 | 4 | — |

SBR: styrene/butadiene copolymer, obtained by emulsion polymerization, containing 40% by weight of styrene, mixed with 37.5 phr of extension oil (marketed by Enichem Elastomeri under the abbreviation SBR 1721);

PVA: polyvinylalcohol obtained by hydrolysis of polyvinylacetate, having hydrolysis degree of 83 mol %, viscosity (DIN 53 015) of 2.8±0.3 mPa-s2, melting point of 180° C., weight-average molecular weight M_{w} of 18,000 (marketed by Clariant Italia under the trademark Mowiol® 3-83);

PE-MA: polyethylene grafted with 0.5% by weight of maleic anhydride, having a Melt Flow Index (at 190° C. and 2.16 kg) of 4 (marketed by Elf Atochem under the trademark Orevac® OE 330).

### EXAMPLES 4-5

Sulfur-vulcanizable rubber compositions filled with silica were prepared. The compositions are reported in Table 2A (in phr). The masterbatch of PVA was used as a partial replacement of silica.

All the ingredients, except for sulfur and the accelerators were mixed in an internal mixer (model Pomini PL 1.6) for about 3-5 min (lst step). As soon as the temperature of 145±5° C. was reached, the rubber composition was discharged. Thereafter, sulfur and the accelerating agents were added by mixing in a laboratory cylinder open mixer (2nd step).

TABLE 2A

| Example | 4 (*) | 5 |
|---|---|---|
| 1st step | | |
| SBR | 84 | 65.3 |
| BR | 39 | 39 |
| Silica | 70 | 60 |
| Masterbatch (Ex. 1) | — | 25 |
| Silane | 5.6 | 5.6 |
| Stearic acid | 2 | 2 |
| ZnO | 2.5 | 2.5 |
| Aromatic oil | 5 | 5 |
| Antioxidant | 2 | 2 |
| Microcrystalline wax | 1 | 1 |
| 2nd step | | |
| Sulfur | 1.4 | 1.4 |
| DPG | 1.9 | 1.9 |
| CBS | 1.8 | 1.8 |

(*) comparative

SBR: styrene/butadiene copolymer, obtained by emulsion polymerization, containing 25% by weight of styrene, mixed with 37.5 phr of extension oil (marketed by Bayer under the abbreviation SBR 5025);

BR: cis-1,4-polybutadiene (product Europrene Neocis® BR 40—Enichem Elastomeri);

DPG: diphenylguanidine (product Vulkacit® D—Bayer);

CBS: N-cyclohexyl-2-benzothiazyl-sulfenamide (product Vulkacit® CZ—Bayer);

Silica: precipitated silica (product Zeosil® 1165 MP—Rhône-Poulenc);

Silane: bis(3-triethoxysilylpropyl)tetrasulfide (product X50S comprising 50% carbon black and 50% silane—Degussa) (the value reported in the table refer to the actual amount of added silane);

Antioxidant: phenyl-p-phenylene diamine.

The Mooney viscosity ML(1+4) at 100° C. (according to standard ISO 289/1) of the above compositions was measured after 1 day and after 8 days of storage at room temperature. The results are reported in Table 2B.

The compositions thus prepared were submitted to MDR rheometric analysis utilizing a Monsanto MDR rheometer, carrying out the tests at 151° C. for 60 min with an oscillation frequency of 1.66 Hz (100 oscillations per minute) and an oscillation amplitude of +0.5°. The mechanical properties (according to standard ISO 37) and the hardness in IRHD degrees at 23° C. and 100° C. (according to ISO standard 48) were measured on samples of the aforesaid compositions cross-linked at 151° C. for 30 minutes. The results are shown in Table 2B.

Table 2B also shows the dynamic elastic properties, measured with a dynamic Instron device in the traction-compression mode according to the following method. A test piece of the cross-linked material having a cylindrical form (length=25 mm; diameter=14 mm), compression-preloaded up to a 10% longitudinal deformation with respect to the initial length, and kept at the prefixed temperature (70° C. or 10° C.) for the whole duration of the test, was submitted to a dynamic sinusoidal strain having an amplitude of ±3.33% with respect to the length under pre-load, with a 100 Hz frequency. The dynamic elastic properties are expressed in terms of dynamic elastic modulus (E′) and tandelta (loss factor) values. As is known, the tandelta value is calculated as a ratio between the viscous modulus (E″) and the elastic modulus (E′), both of them being determined with the above dynamic measurements.

Lastly, the DIN abrasion values were measured according to ISO standard 4649, also reported in Table 2B, expressed as relative volumetric loss with respect to the reference composition of Example 4 (assumed to be 100).

TABLE 2B

| Example | 4 (*) | 5 |
|---|---|---|
| Mooney viscosity ML | | |
| (1 + 4) at 100° C. | | |
| after 1 day | 68 | 60 |
| after 8 days | 70 | 60 |
| Max torque (dN · m) | 23.1 | 22.2 |
| Min torque (dN · m) | 3.0 | 2.3 |
| Delta torque (dN · m) | 20.1 | 19.9 |
| t90 (min) | 21.0 | 20.0 |
| 100% Modulus (MPa) | 2.50 | 2.70 |
| 300% Modulus (MPa) | 9.59 | 9.55 |
| Stress at break (MPa) | 16.20 | 15.30 |
| Elongation at break (%) | 485 | 435 |
| 300% Mod./100% Mod. | 3.8 | 3.5 |
| E′ (70° C.) (MPa) | 6.20 | 6.39 |
| E′ (10° C.) (MPa) | 8.42 | 9.46 |
| Tandelta (70° C.) | 0.112 | 0.095 |
| Tandelta (10° C.) | 0.270 | 0.254 |
| IRHD hardness at 23° C. | 74 | 73 |
| IRHD hardness at 100° C. | 69 | 68 |
| DIN abrasion | 100 | 105 |

(*) comparative

### EXAMPLES 6-9

Sulfur-vulcanizable rubber compositions filled with silica were prepared with the same method described for Examples 4-5. The compositions are reported in Table 3A (in phr). The masterbatch of PVA was used as an additive, maintaining the same amount of silica. For comparative purposes, the same compositions were prepared wherein polyethylene glycol (PEG 600) or sorbitol mono-oleate were used as silica stabilizers instead of the PVA masterbatch.

The same measurements of Examples 4-5 were carried out on the rubber compositions thus obtained. The results are shown in Table 3B.

TABLE 3A

| Example | 6 (*) | 7 | 8 (*) | 9 (*) |
|---|---|---|---|---|
| SBR | 90 | 77.5 | 90 | 90 |
| BR | 35 | 35 | 35 | 35 |
| Silica | 70 | 70 | 70 | 70 |
| Masterbatch (Ex. 2) | — | 16.7 | — | — |
| PEG 600 | — | — | 3.5 | — |
| SMO | — | — | — | 3.5 |
| Silane | 5.6 | 5.6 | 5.6 | 5.6 |
| Stearic acid | 2 | 2 | 2 | 2 |
| ZnO | 2.5 | 2.5 | 2.5 | 2.5 |
| Aromatic oil | 8 | 8 | 8 | 8 |
| Antioxidant | 2 | 2 | 2 | 2 |
| Microcrystalline wax | 1 | 1 | 1 | 1 |
| Sulfur | 1.2 | 1.2 | 1.2 | 1.2 |
| DPG | 1.9 | 1.9 | 1.9 | 1.9 |
| CBS | 2 | 2 | 2 | 2 |

(*) comparative

SBR: styrene/butadiene copolymer, obtained by emulsion polymerization, containing 25% by weight of styrene, mixed with 37.5 phr of extension oil (marketed by Bayer under the abbreviation SBR 5025);

BR: cis-1,4-polybutadiene (product Europrene Neocis® BR 40—Enichem Elastomeri);

PEG 600: polyethylenglycol (product Lipoxol® 600-Condea Chemie GmbH);

SMO: sorbitan mono-oleate (product Span® 80—ICI)

DPG: diphenylguanidine (product Vulkacit® D—Bayer); CBS: N-cyclohexyl-2-benzothiazyl-sulfenamide (product Vulkacit® CZ—Bayer);

Silane: bis(3-triethoxysilylpropyl)tetrasulfide (product X50S comprising 50% carbon black and 50% silane—Degussa) (the value reported in the table refer to the actual amount of added silane);

Antioxidant: phenyl-p-phenylene diamine.

TABLE 3B

| Example | 6 (*) | 7 | 8 (*) | 9 (*) |
|---|---|---|---|---|
| Mooney viscosity ML | | | | |
| (1 + 4) at 100° C. | | | | |
| after 1 day | 73 | 68 | 67 | 61 |
| after 7 days | 76 | 71 | 69 | 63 |
| after 14 days | 78 | 75 | 72 | 65 |
| after 28 days | 85 | 82 | 79 | 70 |
| Max torque (dN · m) | 20.1 | 22.6 | 24.0 | 17.1 |
| Min torque (dN · m) | 4.6 | 3.2 | 3.1 | 2.5 |
| Delta torque (dN · m) | 15.5 | 19.4 | 20.9 | 14.6 |
| t90 (min) | 14.8 | 12.6 | 18.6 | 16.6 |
| 100% Modulus (MPa) | 2.0 | 2.6 | 2.8 | 1.8 |
| 300% Modulus (MPa) | 9.1 | 11.8 | n.d. | 8.1 |
| Stress at break (MPa) | 12.5 | 12.9 | 11.8 | 11.7 |
| Elongation at break (%) | 405 | 349 | 299 | 420 |
| 300% Mod./100% Mod. | 4.5 | 45 | — | 4.5 |
| E′ (70° C.) (MPa) | 5.9 | 7.3 | 7.5 | 5.4 |
| E′ (10° C.) (MPa) | 9.6 | 13.6 | 13.0 | 8.9 |
| Tandelta (70° C.) | 0.141 | 0.146 | 0.120 | 0.142 |
| Tandelta (10° C.) | 0.361 | 0.356 | 0.352 | 0.379 |
| IRHD hardness at 23° C. | 70 | 77 | 71 | 67 |
| IRHD hardness at 100° C. | 65 | 70 | 67 | 62 |
| DIN abrasion | 100 | 98 | 97 | 97 |

(*) comparative
n.d.: not determinable

### EXAMPLES 10-13

Sulfur-vulcanizable rubber compositions, filled with a mixture of silica and carbon black, were prepared with the same method described for Examples 4-5. The compositions are reported in Table 4A (in phr). The masterbatch of PVA was used as a partial replacement of carbon black, while maintaining the same amount of silica. In Example 13 a condensation catalyst (DBTL) was added.

The same measurements of Examples 4-5 were carried out on the rubber compositions thus obtained. The results are shown in Table 4B.

TABLE 4A

| Example | 10 (*) | 11 | 12 | 13 |
|---|---|---|---|---|
| SBR | 75 | 75 | 75 | 75 |
| BR | 25 | 25 | 25 | 25 |
| Silica | 35 | 35 | 35 | 35 |
| Carbon black | 35 | 25 | 25 | 25 |
| Masterbatch (Ex. 1) | — | 29 | — | 29 |
| Masterbatch (Ex. 3) | — | — | 29 | — |
| DBTL | — | — | — | 0.35 |
| Silane | 3.5 | 3.5 | 3.5 | 3.5 |
| Stearic acid | 2 | 2 | 2 | 2 |
| ZnO | 3 | 3 | 3 | 3 |
| Aromatic oil | 15 | 15 | 15 | 15 |
| Antioxidant | 2 | 2 | 2 | 2 |
| Microcrystalline wax | 1 | 1 | 1 | 1 |
| Sulfur | 1.2 | 1.2 | 1.2 | 1.2 |
| CBS | 2.5 | 2.5 | 2.5 | 2.5 |

(*) comparative

SBR: styrene/butadiene copolymer, obtained by emulsion polymerization, containing 40% by weight of styrene, mixed with 37.5 phr of extension oil (marketed by Bayer under the abbreviation SBR 1721);

BR: cis-1,4-polybutadiene (product Europrene Neocis® BR 40—Enichem Elastomeri);

CBS: N-cyclohexyl-2-benzothiazyl-sulfenamide (product Vulkacit® CZ—Bayer);

DBTL: dibutyl tin dilaurate

Silane: bis(3-triethoxysilylpropyl)tetrasulfide (product X50S comprising 50% carbon black and 50% silane—Degussa) (the value reported in the table refer to the actual amount of added silane);

Antioxidant: phenyl-p-phenylene diamine.

TABLE 4B

| Example | 10 (*) | 11 | 12 | 13 |
|---|---|---|---|---|
| Mooney viscosity ML | | | | |
| (1 + 4) at 100° C. | | | | |
| after 1 day | 68 | 55 | 57 | 44 |
| after 60 days | 85 | 60 | 62 | — |
| Max torque (dN · m) | 16.5 | 16.4 | 16.5 | 16.9 |
| Min torque (dN · m) | 3.1 | 2.6 | 2.8 | 2.1 |
| Delta torque (dN · m) | 13.4 | 13.8 | 13.7 | 14.8 |
| t90 (min) | 15.0 | 15.0 | 15.0 | 10.45 |
| 100% Modulus (MPa) | 2.5 | 2.6 | 2.7 | 2.5 |
| 300% Modulus (MPa) | 11.0 | 11.2 | 11.5 | 10.5 |
| Stress at break (MPa) | 17.3 | 16.4 | 16.1 | 17 |
| Elongation at break (%) | 474 | 456 | 441 | 493 |
| 300% Mod./100% Mod. | 4.4 | 4.3 | 4.3 | 4.2 |
| E′ (70° C.) (MPa) | 6.1 | 6.0 | 5.9 | 5.4 |
| E′ (10° C.) (MPa) | 14.9 | 15.5 | 14.8 | 15.1 |
| Tandelta (70° C.) | 0.230 | 0.200 | 0.196 | 0.194 |
| Tandelta (10° C.) | 0.609 | 0.569 | 0.575 | 0.582 |
| IRHD hardness at 23° C. | 75 | 74 | 73 | 74 |
| IRHD hardness at 100° C. | 63 | 62 | 63 | 60 |
| DIN abrasion | 100 | 102 | 104 | 103 |

(*) comparative

1. Method for improving processability and storage stability of a silica filled elastomeric composition, said method comprising mixing at least an elastomeric diene polymer with a reinforcing filler comprising silica, characterized in that said method further comprises adding to said composition a thermoplastic polymer having a main hydrocarbon chain to which hydroxy groups are linked, said polymer containing hydroxy groups having a weight-average molecular weight of at least 8,000.

2. Method according to claim 1, wherein the polymer containing hydroxy groups has a weight-average molecular weight of from 10,000 to 150,000.

3. Method according to claim 2, wherein the polymer containing hydroxy groups has a weight-average molecular weight of from 12,000 to 50,000.

4. Method according to anyone of the preceding claims, wherein the polymer containing hydroxy groups has a melting point of at least 160° C.

5. Method according to claim 4, wherein the polymer containing hydroxy groups has a melting point of from 170° to 230° C.

6. Method according to claim 5, wherein the polymer containing hydroxy groups has a melting point of from 180° C. to 220° C.

7. Method according to anyone of the preceding claims, wherein the polymer containing hydroxy groups is added in an amount of from 0.1 to 60 phr.

8. Method according to anyone of the preceding claims, wherein the polymer containing hydroxy groups is selected from: polyhydroxyalkylacrylate, polyvinylalcohol, vinylalcohol/vinylacetate copolymers, ethylene/vinylalcohol copolymers, ethylene/vinylalcohol/vinylacetate terpolymers, and mixtures thereof.

9. Method according to claim 8, wherein the polymer containing hydroxy groups is selected from:
(i) vinylalcohol polymers obtained by hydrolysis of polyvinylacetate, with a hydrolysis degree of from 50 to 100 mol %;
(ii) ethylene/vinylalcohol copolymers having a content of ethylene units of from 20 to 60 mol %.

10. Method according to anyone of the preceding claims, further comprising adding to said composition a polymer containing functional groups reactive with said hydroxy groups.

11. Method according to claim 10, wherein the functionalized polymer is a thermoplastic hydrocarbon polymer containing groups selected from: carboxylic groups, anhydride groups, ester groups, silane groups, epoxy groups, or combinations thereof.

12. Method according to claim 10 or 11, wherein the functionalized polymer is added to the elastomeric composition in an amount so as to obtain a weight ratio between the polymer containing hydroxy groups and the functionalized polymer of from 0.5:1 to 10:1.

13. Method according to anyone of the preceding claims, wherein the polymer containing hydroxy groups is added to said composition pre-dispersed in an elastomeric polymer.

14. Method according to claim 13, wherein the polymer containing hydroxy groups is added to said composition pre-dispersed in an elastomeric polymer in combination with the functionalized polymer.

15. Method according to claim 13 or 14, wherein the polymer containing hydroxy groups and, optionally, the functionalized polymer are pre-dispersed in the elastomeric polymer by means of a continuous mixer at a temperature of from 180° to 230° C.

16. Method according to anyone of the preceding claims, wherein silica is added in an amount of from 0.1 to 120 phr.

17. Method according to claim 16, wherein silica is added in an amount of from 20 and 90 phr.

18. Method according to anyone of the preceding claims, further comprising adding to said composition carbon black as additional reinforcing filler.

19. Method according to anyone of the preceding claims, further comprising adding to said composition a silica coupling agent.

20. Method according to anyone of the preceding claims, further comprising adding to said composition an effective amount of a silanol condensation catalyst.

21. Method according to claim 20, wherein the silanol condensation catalyst is dibutyltin dilaurate.

22. An elastomeric composition comprising:
at least an elastomeric diene polymer;
at least a reinforcing filler comprising silica;
at least a thermoplastic polymer having a main hydrocarbon chain to which hydroxy groups are linked, said polymer containing hydroxy groups having a weight-average molecular weight of at least 8,000;
with the proviso that, when said polymer containing hydroxy groups is poly(ethylene-vinylalcohol), the composition is substantially devoid of destructured starch.

23. Composition according to claim 22, wherein the polymer containing hydroxy groups has a weight-average molecular weight of from 10,000 to 150,000.

24. Composition according to claim 23, wherein the polymer containing hydroxy groups has a weight-average molecular weight of from 12,000 to 50,000.

25. Composition according to anyone of claims from 22 to 24, wherein the polymer containing hydroxy groups has a melting point of at least 160° C.

26. Composition according to claim 25, wherein the polymer containing hydroxy groups has a melting point of from 170° to 230° C.

27. Composition according to claim 26, wherein the polymer containing hydroxy groups has a melting point of from 180° C. to 220° C.

28. Composition according to anyone of claims from 22 to 27, wherein the polymer containing hydroxy groups has a melting point of at least 160° C.

29. Composition according to claim 28, wherein the polymer containing hydroxy groups has a melting point of from 170° C. to 230° C.

30. Composition according to claim 29, wherein the polymer containing hydroxy groups has a melting point of from 180° C. to 220° C.

31. Composition according to anyone of claims from 22 to 30, wherein the polymer containing hydroxy groups is present in an amount of from 0.1 to 60 phr.

32. Composition according to anyone of claims from 22 to 31, wherein the polymer containing hydroxy groups is selected from: polyhydroxyalkylacrylate, polyvinylalcohol, vinylalcohol/vinylacetate copolymers, ethylene/vinylalcohol copolymers, ethylene/vinylalcohol/vinylacetate terpolymers, and mixtures thereof.

33. Composition according to anyone of claims from 22 to 32, wherein the polymer containing hydroxy groups comprises repeating units having the formula 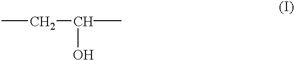
with a random or block distribution along the chain.

34. Composition according to claim 33, wherein the polymer containing hydroxy groups is selected from:
(i) vinylalcohol polymers obtained by hydrolysis of polyvinylacetate, with a hydrolysis degree of from 50 to 100 mol %;
(ii) ethylene/vinylalcohol copolymers having a content of ethylene units of from 20 to 60 mol %.

35. Composition according to anyone of claims from 22 to 34, further comprising a polymer containing functional groups reactive with said hydroxy groups.

36. Composition according to claim 35, wherein the functionalized polymer is a thermoplastic hydrocarbon polymer containing groups selected from: carboxylic groups, anhydride groups, ester groups, silane groups, epoxy groups, or combinations thereof.

37. Composition according to claim 35 or 36, wherein the functionalized polymer is present in an amount so as to obtain a weight ratio between the polymer containing hydroxy groups and the functionalized polymer of from 0.5:1 to 10:1.

38. Composition according to anyone of claims from 35 to 37, wherein the functionalized polymer has an amount of functional groups of from 0.05 to 50 parts by weight, based on 100 parts by weight of the polymer.

39. Composition according to claim 38, wherein the functionalized polymer has an amount of functional groups of from 0.1 to 10 parts by weight, based on 100 parts by weight of the polymer.

40. Composition according to anyone of claims from 22 to 39, wherein the polymer containing hydroxy groups is pre-dispersed in an elastomeric polymer.

41. Composition according to claim 40, wherein the polymer containing hydroxy groups is pre-dispersed in an elastomeric polymer in combination with the functionalized polymer.

42. Composition according to anyone of claims from 22 to 41, wherein silica is present in an amount of from 0.1 to 120 phr.

43. Composition according to claim 42, wherein silica is present in an amount of from 20 and 90 phr.

44. Composition according to anyone of claims from 22 to 43, wherein the reinforcing filler further comprises carbon black.

45. Composition according to anyone claims from 22 to 44, further comprising a silica coupling agent.

46. Composition according to anyone of claims from 22 to 45, further comprising sulfur or a sulfur-containing vulcanizing agent.

47. Elastomeric article obtained by cross-linking the elastomeric composition according to anyone of claims from 22 to 46.

48. Tyre for vehicle wheels comprising at least an element including an elastomeric material, characterized in that said elastomeric material is obtained by cross-linking a composition comprising:
at least an elastomeric diene polymer;
at least a reinforcing filler comprising silica;
at least a thermoplastic polymer having a main hydrocarbon chain to which hydroxy groups are linked, said polymer containing hydroxy groups having a weight-average molecular weight of at least 8,000.

49. Tyre according to claim 48, wherein said element including said composition is a tread belt.

50. Tyre according to claim 48 or 49, wherein said composition is defined according to anyone of claims from 22 to 46.

51. Tread belt comprising an elastomeric composition according to anyone of claims from 22 to 46.
